(19) United States
(12) Patent Application Publication
(10) Pub. No.: US 2007/0071268 A1
(43) Pub. Date: Mar. 29, 2007

(54) Packaged microphone with electrically coupled lid

(75) Inventors: Kieran Harney, Andover, MA (US); John R. Martin, Foxborough, MA (US); Lawrence Felton, Hopkinton, MA (US)

Correspondence Address: BROMBERG & SUNSTEIN LLP, 125 SUMMER STREET, BOSTON, MA, 02110-1618, US

(73) Assignee: Analog Devices, Inc.

(21) Appl. No.: 11/366,941

(22) Filed: Mar. 2, 2006

Related U.S. Application Data
(60) Provisional application No. 60/708,449, filed on Aug. 16, 2005.

(51) Int. Cl. H04R 11/04

(52) U.S. Cl. 381/355

(57) ABSTRACT

An apparatus has a leadframe based package base having a leadframe, and a lid coupled with the package base. The lid and package base form a chamber for at least partially containing a microphone. The lid is electrically coupled with a given portion of the leadframe in the package base.

### PRIORITY

This patent application claims priority from provisional U.S. patent application No. 60/708,449, filed Aug. 16, 2005, attorney docket number 2550/A74, entitled, “MICROPHONE WITH PREMOLDED TYPE PACKAGE,” and naming Lawrence Felton, Kieran Harney, and John R. Martin as inventors, the disclosure of which is incorporated herein, in its entirety, by reference.

### FIELD OF THE INVENTION

The invention generally relates to packages for electronic devices and, more particularly, the invention relates to packages for MEMS devices.

### BACKGROUND OF THE INVENTION

Known MEMS microphones typically are formed on a substrate, such as a printed circuit board, or as single/multiple chips secured within a ceramic package. For example, in one known design, a microphone chip 18 is secured within an open cavity formed by a ceramic package. A lid having an audio port hole mostly encloses this cavity to provide additional environmental protection. Of course, the port hole opens this cavity to the exterior atmosphere.

Problems arise with this microphone packaging design when the lid accumulates a static charge. Among other problems, charge built up on/in the lid could interfere with the workings of the MEMS components (e.g., movement of a diaphragm). For example, the charge could attract the movable diaphragm, thus impacting microphone performance. In addition, if it is conductive but has no significant potential difference from parts of the package, the lid could act as a part of a shield against external electromagnetic interference (“EMI”). Its impact as an EMI shield diminishes, however, if its potential is different than the charge of other portions of such a shield.

### SUMMARY OF THE INVENTION

In accordance with one aspect of the invention, an apparatus has a leadframe based package base having a leadframe, and a lid coupled with the package base. The lid and package base form a chamber for at least partially containing a microphone. The lid is electrically coupled with a given portion of the leadframe in the package base.

In illustrative embodiments, the package base is a premolded-type package base. Moreover, the lid may have a top member and a downwardly extending member extending toward the package base. The downwardly extending member electrically contacts the given portion of the leadframe. In addition, the package base may be substantially flat, while the lid has an acoustic port. The package base, downwardly extending member and top member can form the chamber, which opens to the acoustic port.

Among other things, the leadframe has the given portion and a different portion, and the given portion is electrically isolated from the different portion. Consequently, the two leadframe portions can have different potentials. For example, the given portion could be relative ground, while the other portion can have a positive potential. In addition, the lid illustratively has substantially the same potential as the given portion of the leadframe.

The lid may have a conductive layer that electrically connects with the given portion of the leadframe. Moreover, the package base may include a base portion and a wall extending toward the lid. The wall may have a conductor that electrically connects the lid to the leadframe. In some embodiments, the package base has a wall with a recess that exposes the given portion of the leadframe. The wall may be conductive or insulative. In either case, the lid may have a downwardly extending portion secured in registry with the recess to electrically contact the given portion of the leadframe.

The microphone may be any of various different types of microphones. In illustrative embodiments, however, the microphone is a MEMS device. In accordance with another aspect of the invention, a method of forming a transducer device provides a premolded type leadframe package base having a ground lead and a signal lead. The method secures a MEMS microphone to the package base, and then secures a lid to the package base to form an internal chamber containing the microphone. The method also electrically connects the lid to the ground lead to cause the lid and ground lead to have substantially the same potential.

The method also may electrically connect the MEMS microphone to the signal lead. In some embodiments, the lid has a top face and a wall extending generally downwardly from the top face, while the wall has a conductive portion. In that case, the method may electrically connect the conductive portion of the wall to the ground lead. In other embodiments, the method secures the lid to the package base by applying a conductive adhesive between the lid and package base to provide an electrical path between the package base and the lid. Moreover, the MEMS microphone may have a die with a bottom surface. In such case, the method may secure the MEMS microphone to the package base by securing the bottom face of the MEMS microphone to the ground lead.

### BRIEF DESCRIPTION OF THE DRAWINGS

The various advantages of the invention should be appreciated more fully from the below description, which frequently refers to the accompanying drawings. Those drawings are briefly summarized below.

FIG. 1A schematically shows a top, perspective view of a packaged microphone that may be configured in accordance with illustrative embodiments of the invention.

FIG. 1B schematically shows a bottom, perspective view of the packaged microphone shown in FIG. 1A.

FIG. 2 schematically shows a cross-sectional view of a microphone chip that may be used in illustrative embodiments of the invention.

FIG. 3A schematically shows a plan view of a package base that may be used in accordance with illustrative embodiments of the invention.

FIG. 3B schematically shows a cross-sectional view of a packaged microphone using the base shown in FIG. 3A.

FIG. 4 schematically shows a cross-sectional view of an alternative embodiment of a packaged microphone.

FIG. 5A schematically shows a plan, cross-sectional view of a packaged microphone in accordance with other embodiments of the invention.

FIG. 5B schematically shows a partially exploded, side view of the packaged microphone shown in FIG. 5A.

FIG. 6 schematically shows a cross-sectional view of yet another embodiment of the invention.

FIG. 7 shows a process of producing a packaged microphone in accordance with illustrative embodiments of the invention.

### DESCRIPTION OF ILLUSTRATIVE EMBODIMENTS

In illustrative embodiments of the invention, a premolded package has a corresponding lid that electrically connects with a specific portion of the package leadframe. The lid therefore is grounded if the specific leadframe portion also is grounded, thus minimizing charge buildup in the lid while improving protection against electromagnetic interference (EMI). Details of illustrative embodiments are discussed below.

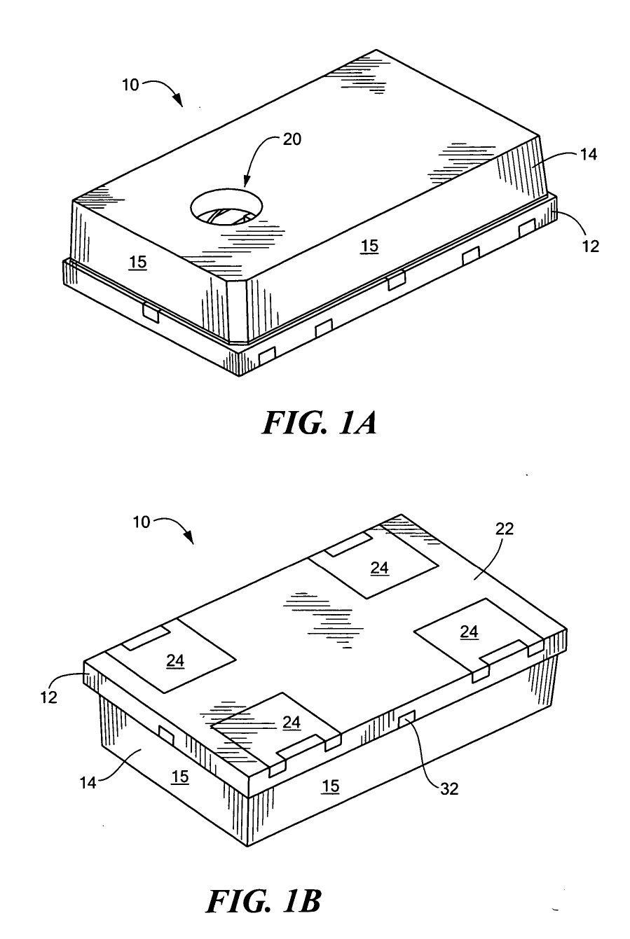

FIG. 1A schematically shows a top, perspective view of a packaged microphone 10 that may be configured in accordance with illustrative embodiments of the invention. In a corresponding manner, FIG. 1B schematically shows a bottom, perspective view of the same packaged microphone 10.

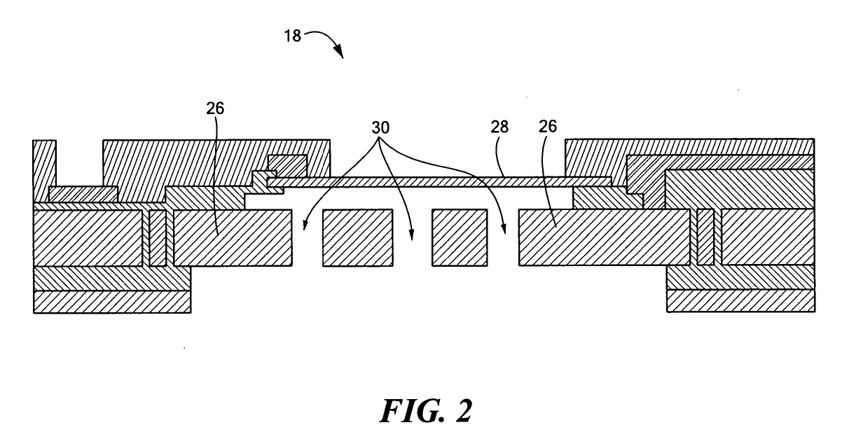

The microphone shown in those figures has a package base 12 that, together with a corresponding lid 14, forms an interior chamber 16 containing a microphone chip 18 (discussed below, see FIG. 2) and, if desired, microphone circuitry. The lid 14 in this embodiment is a cavity-type lid, which has four walls 15 extending generally orthogonally from a top, interior face to form a cavity. The lid 14 secures to the top face of the substantially flat package base 12 to form the interior chamber 16.

The lid 14 also has an audio input port 20 that enables ingress of audio signals into the chamber 16. In alternative embodiments, however, the audio port 20 is at another location, such as through the package base 12, or through one of the side walls 15 of the lid 14. Audio signals entering the interior chamber 16 interact with the microphone chip 18 to produce an electrical signal that, with additional (exterior) components (e.g., a speaker and accompanying circuitry), produce an output audible signal corresponding to the input audible signal.

FIG. 1B shows the bottom face 22 of the package base 12, which has a number of contacts 24 for electrically (and physically, in many anticipated uses) connecting the microphone with a substrate, such as a printed circuit board or other electrical interconnect apparatus. The packaged microphone 10 may be used in any of a wide variety of applications. For example, the packaged microphone 10 may be used with mobile telephones, land-line telephones, computer devices, video games, biometric security systems, two-way radios, public announcement systems, and other devices that transduce signals. In fact, it is anticipated that the packaged microphone 10 could be used as a speaker to produce audible signals from electronic signals.

In illustrative embodiments, the package base 12 is a premolded, leadframe-type package (also referred to as a “premolded package”). As known by those in the art, a premolded package has a leadframe with a moldable material (e.g., polymeric material, such as plastic) molded directly to the leadframe. Such package type generally is formed before the chip is secured to it. This package type thus typically is ready to accept a chip without requiring any additional molding operations. In other words, a premolded, leadframe-type package is ready made to package an electronic chip. This is in contrast to conventional plastic packages (also referred to as “overmolded” packages), for example, that apply molten plastic to the chip after it is coupled with some leads, such as those of a leadframe.

Those in the art also understand that there are various types of premolded packages. For example, the package base 12 shown in FIGS. 1A and 1B is a substantially flat type premolded package base 12. In other words, the package base 12 essentially forms a three dimensional cuboid, subject to some surface height aberrations that do not significantly affect its general shape. In some embodiments, however, the package base 12 has walls 46 that form a cavity with its bottom face 22. Specifically, this type of premolded package may be considered to be substantially similar to a flat type premolded package base 12, but with upwardly extending walls 46. In that instance, the lid 14 may be substantially flat, or have the generally orthogonal walls 15 discussed above. Various embodiments having such features are discussed below.

FIG. 2 schematically shows a cross-sectional view of an unpackaged MEMS microphone 18 (also referred to as a “microphone chip 18”) that may be used in accordance with illustrative embodiments of the invention. This microphone chip 18 is shown as an example only and thus, discussion of various of its specific components are illustrative and not intended to limit the scope of all embodiments.

Among other things, the microphone chip 18 includes a static backplate 26 that supports and forms a variable capacitor with a flexible diaphragm 28. In illustrative embodiments, the backplate 26 is formed from single crystal silicon (e.g., a part of a silicon-on-insulator wafer or a bulk silicon wafer), while the diaphragm 28 is formed from deposited polysilicon. In other embodiments, however, the backplate 26 may be formed from another material, such as polysilicon. To facilitate operation, the backplate 26 has a plurality of through-holes 30 that lead to a back-side cavity.

Audio signals cause the diaphragm 28 to vibrate, thus producing a changing capacitance. On-chip or off-chip circuitry converts this changing capacitance into electrical signals that can be further processed. This circuitry may be within the package discussed above, or external to the package.

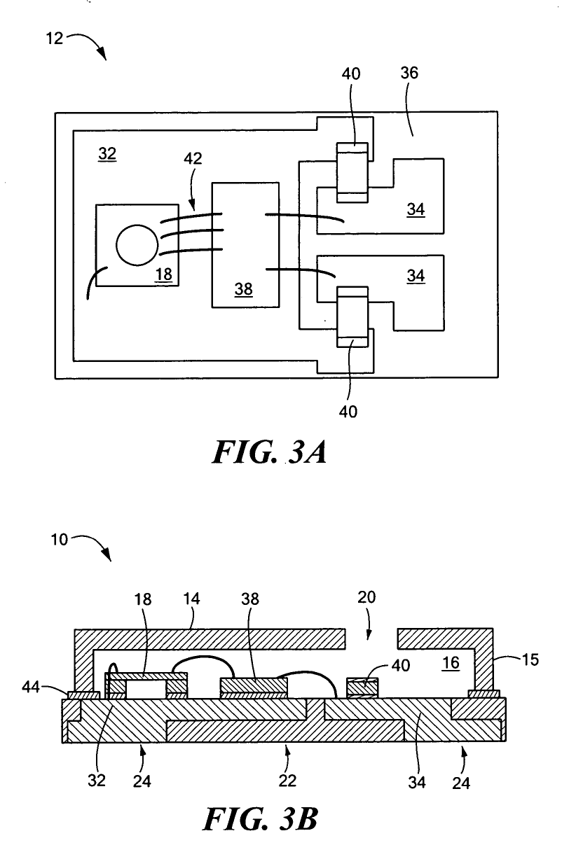

FIG. 3A schematically shows a plan view of the package base 12 configured in accordance with illustrative embodiments of the invention. As discussed above, this package base 12 is substantially flat and supports a number of functional components. Specifically, the leadframe of the package base 12 has a relatively large ground lead 32 (also referred to in the art as a “die paddle”), a pair of signal leads 34, and polymeric material 36 between the leads. Each of the leads illustratively extends to and terminates at an exposed contact 24 on the bottom face 22 of the package base 12. It should be noted that the package base 12 may have different numbers and types of leads. For example, the package base 12 may have more or fewer signal leads 34, and/or also have power leads. Some of the package base 12 leads may be in electrical contact with other leads, while others may be entirely isolated.

The polymeric material 36 illustratively is a molded material, such as plastic, that is molded in a planar manner to give the package base 12 its substantially planar profile. Moreover, the polymeric material 36 also electrically isolates various of the leads from the other leads. Accordingly, the ground leads 32 may be set to a substantially ground potential, while the signal leads 34 may be set to another potential. For example, the signal leads 34 could receive signal data from an external component, and/or transmit signal data to an external component via a coupled circuit board. Moreover, the ground lead 32 can be set to ground potential, which, as noted above, also grounds the lid 14.

The topology of the contacts 24 on the bottom face 22 of the package base 12 illustratively is different from that of the top face of the package base 12 (shown in FIG. 3A). For example, the topology on the bottom face 22 of the package base 12 may be similar to that shown in FIG. 1B. Various etching techniques, such as half-etching and related timed etches, can be used to produce this disparate topology. For additional information regarding the disparate base topology, see, for example, co-pending U.S. patent application Ser. No. 11/338,439 entitled, “Partially Etched Leadframe Packages Having Different Top and Bottom Topologies,” naming Kieran P. Harney, John R. Martin, and Lawrence E. Felton as inventors, and filed Jan. 24, 2006, the disclosure of which is incorporated herein, in its entirety, by reference.

In other embodiments, one or more of the leads on the top face of the package base 12 may extend to contacts 24 at different portions of the package base 12 (i.e., portions of the base 12 other than at the bottom face 22). For example, that other portion may be another lead on the top face, or contacts 24 on the side of the package base 12. Moreover, in yet other embodiments, the topology on both faces of the package base 12 may be substantially the same. Accordingly, discussion of the specific topologies of the leads and contacts 24 is meant to be illustrative and not limiting to various embodiments of the invention.

The components secured to the package base 12 may be devices conventionally used by those skilled in the art. For example, the components may include one or more MEMS microphone chips 18, such as that discussed above with regard to FIG. 2, a circuitry chip 38 for controlling operation of the microphone chip 18, and other signal conditioning circuitry, such as a pair of capacitors 40. In illustrative embodiments, the circuitry chip 38 is an application specific integrated circuit (ASIC) configured specifically for a given application. As shown, the microphone chip 18 and circuitry chip 38 each are physically secured to the ground lead 32, while the capacitors 40 each are secured between one signal lead 34 and the ground lead 32. A plurality of wire bonds 42 electrically connect each chip with the appropriate leads.

Of course, other configurations of components may be used. For example, the circuitry functionality may be spread out among more than one chips, including within the microphone chip 18. Alternatively, substantially all of the circuitry chip functionality may be integrated within the microphone chip 18.

Accordingly, discussion of specific components is illustrative and not intended to limit some embodiments of the invention.

FIG. 3B schematically shows a cross-sectional view of a packaged microphone 10 using the base 12 shown in FIG. 3A. As shown, the lid 14 is secured to the package base 12 in a manner that electrically contacts at least a portion of the ground lead 32. To that end, the lid 14 is secured to the package base 12 by means of a conductive material, such as a conductive adhesive 44. This figure also shows the input audio port 20, which is spaced away from the microphone chip 18.

The lid 14 may be formed from a number of different materials to accomplish various goals, such as reducing its potential for accumulating charge. Specifically, among other things, the lid 14 may be formed from a conductive plastic, stamped metal, other material having a conductive path for discharging charge, or some combination thereof. For example, the lid 14 may be formed from an insulating plastic material having a plated metal layer that, as shown in FIG. 3B, electrically contacts a portion of the leadframe. Those skilled in the art nevertheless should understand that other types of lids may be used to accomplish the discussed goals.

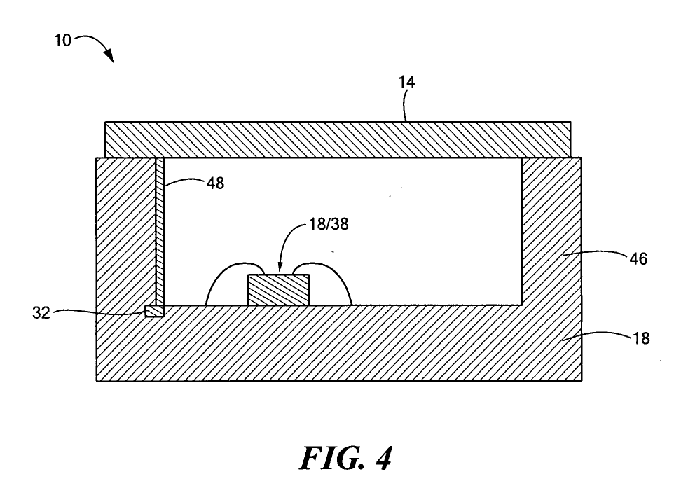

FIGS. 4 through 6 show various other embodiments of the invention. Of course, in a manner similar to the embodiments discussed above, these embodiments also are discussed as examples only and thus, are not intended to limit all embodiments of invention.

Specifically, FIG. 4 shows one embodiment of the invention, in which the package base 12 has a plurality of walls 46 that extend substantially orthogonally from its bottom to form a cavity. It should be noted that one or more of the walls 46 may extend in a non-orthogonal manner, such as by forming an acute and/or obtuse angle with the bottom of the package base 12.

The components, such as the microphone chip 18 and circuitry chip 38 (not shown in this figure), are secured within the cavity and substantially enclosed by the lid 14. In this case, the lid 14 is substantially flat and is secured to the top face of the package base walls 46. Since the package base 12 is formed from a leadframe and polymeric material 36, the walls 46 inherently are substantially insulative. In other words, the walls 46 do not conduct current and thus, cannot act as a conductive path for removing static charge from the lid 14.

To overcome that problem, this embodiment has a conductive path 48 formed in/on at least one of the walls 46 of the package base 12. Specifically, the interior face of at least one of the walls 46 may have a thin sputtered metal coating 48 physically extending between the lid 14 and the ground lead 32. Alternatively, the metal coating 48 may extend to other walls 46 within the cavity. Rather than use a metal coating on the walls 46, other embodiments may impregnate a conductive path directly into the wall 46. In yet other embodiments, the conductive path may be on the exterior face of the wall(s) 46.

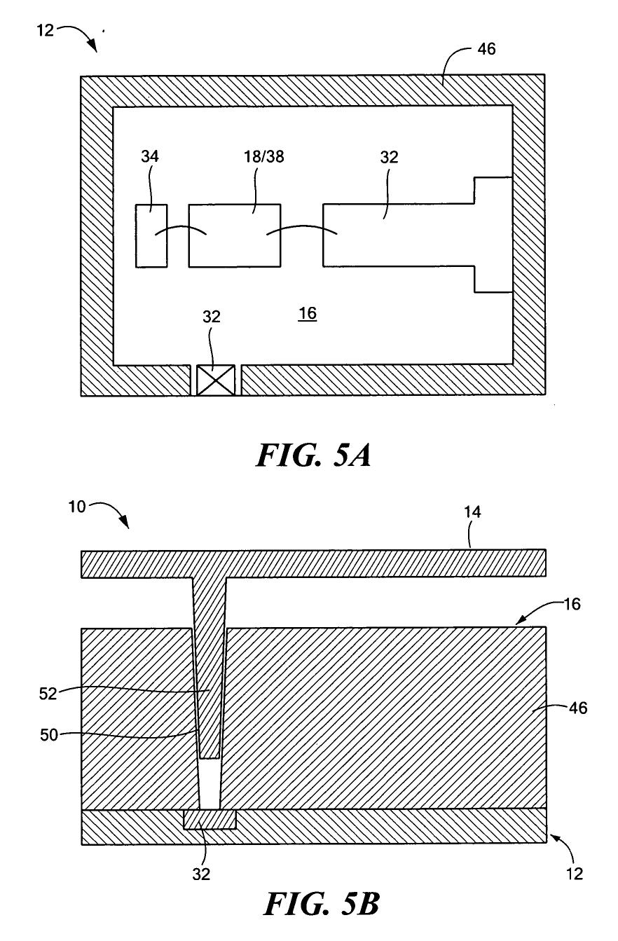

FIGS. 5A and 5B schematically show another alternative embodiment, in which the package base 12 has a wall 46 with a recess 50 exposing the ground lead 32. Specifically, FIG. 5A schematically shows a plan, cross-sectional view of this embodiment, while FIG. 5B schematically shows a partially exploded, side view this embodiment of the packaged microphone 10. In a manner similar to the embodiment shown in FIG. 4, the package base 12 of this embodiment also has four walls 46 that extend substantially orthogonally (in some cases) from its bottom surface toward the lid 14. The wall 46 in this embodiment, however, does not have a conductive path 48 between the lid 14 and the ground lead 32. Instead, the wall 46 forms an opening, referred to above as a recess 50, that exposes the ground lead 32.

As shown in FIG. 5B, to ground the lid 14, the lid 14 has a downwardly extending member 52 that extends through the recess 50 to contact the ground lead 32. Specifically, when secured to the package base 12, this downwardly extending member 52 fits substantially in registry with the recess 50 in the package base 12. To that end, in illustrative embodiments, the downwardly extending member 52 has a shape substantially corresponding to the shape of the recess 50. The package base 12 (with its walls 46), lid 14, and downwardly extending member 52 thus form a chamber 16 that contains the microphone and other components. Of course, this chamber 16 opens to the audio port 20 and thus, is not considered to be a sealed chamber. In a manner similar to other embodiments, the lid 14 may be formed from a material that permits charge to discharge through the downwardly extending member 52 to the ground lead 32.

The wall 46 extending from the bottom of the package base 12 may be a substantial portion of the thickness of the overall packaged microphone 10 (e.g., as shown in FIG. 5B), or it may be a much smaller portion of the total thickness. In some embodiments, the wall 46 is a very small fraction of the total thickness of the overall package microphone. In that case, the downwardly extending member 52 and recess 50 correspondingly are much smaller.

Embodiments with small plastic walls 46 may have a performance advantage over the embodiments having large plastic package walls 46. Specifically, if the lid 14 is conductive, its walls 46 should act as a more effective EMI shield than plastic walls 46 of the package base 12. In other words, grounded, conductive walls forming the cavity should provide better EMI protection than non-conductive, plastic walls. Accordingly, whether they are formed by the lid 14 and/or package base 12, some embodiments should obtain improved results by minimizing the area of the walls having non-conductive properties and maximizing the area of the walls having conductive properties.

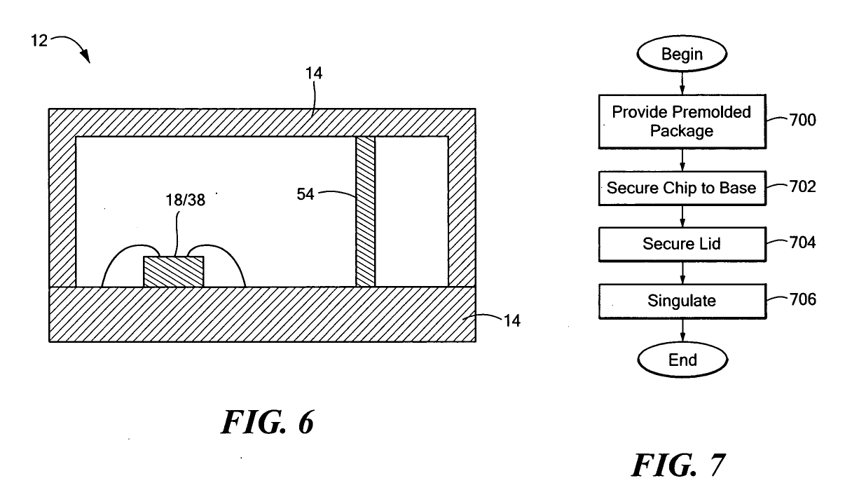

FIG. 6 shows yet another embodiment of the invention, in which a conductive path 54 extends between the ground lead 32 and the lid 14, but is not supported by a wall of either the lid 14 or the package base 12. For example, the conductive path 54 may be a part of the ground lead 32 that is bent upwardly to contact the lid 14. As another example, the conductive path 54 could be a part of the lid 14 that extends downwardly to contact the ground lead 32. In the latter case, the lid 14 may be molded to have a downwardly extending finger or other protrusion that extends to the ground lead 32.

It nevertheless should be noted that those skilled in the art can combine various embodiments discussed herein to form similar packaged microphones. Accordingly, discussion of each specific embodiment with specific components and features is illustrative and not intended to limit all embodiments.

FIG. 7 shows a process of forming a packaged microphone 10 in accordance with illustrative embodiments of the invention. This process may be applied to various of the embodiments discussed above. Specifically, the process begins at step 700, which provides a premolded package. As discussed above, the premolded package may include a substantially flat premolded package base 12, or a premolded package base 12 with walls 46. It should be noted that the package base 12, or both the package base 12 and lid 14 may be considered the “package.” In either case, determination of the type of package is based primarily upon the composition of the package base 12 which, as discussed above, is pre-formed from a leadframe and moldable material (i.e., a premolded package).

The process continues to step 702, which secures the microphone chip 18 and other components to the package base 12 in a conventional manner. For example, the respective bottom faces of the microphone chip 18 and circuitry chip 38 may be physically adhered to the relatively large ground lead 32 (also referred to as the die attach paddle). Appropriate connections may be made, such as by using wire bonds.

After the components are secured to the package base 12, the process secures the lid 14 to the package base 12, thus enclosing (but not sealing because of the audio port 20) the components within the cavity (step 704). To that end, the process may use a conductive adhesive 44 or other material to ensure proper connection. Other conventional means for securing the lid 14 nevertheless may be used. The process concludes at step 706, in which conventional processes dice/saw the various packaged microphones apart to form individual packaged microphones 10.

Those skilled in the art should understand that the steps discussed above are not the only steps required for producing the package microphone 10. Other steps may be performed, but are not mentioned to simplify this discussion. For example, various testing steps may be conducted along the process.

Accordingly, various embodiments of the invention enable the use of premolded-type packages while mitigating the potential impact of electromagnetic interference and static charge buildup in the lid 14. Packaged microphones 10, as well as other packaged microchips (e.g., MEMS and non-MEMS inertial sensors, such as accelerometers and gyroscopes, or integrated circuits), therefore may be produced in high volume batch processes. Consequently, when compared to competing package technologies, such as circuit board/substrate packaging technologies, various embodiments should improve production efficiency and reduce per-part costs.

Although the above discussion discloses various exemplary embodiments of the invention, it should be apparent that those skilled in the art can make various modifications and combinations of various discussed embodiments that will achieve some of the advantages of the invention without departing from the true scope of the invention.

What is claimed is:

1. An apparatus comprising:
a microphone;
a leadframe based package base having a leadframe; and
a lid coupled with the package base, the lid and package base forming a chamber for at least partially containing the microphone,
the lid being electrically coupled with a given portion of the leadframe in the package base.

2. The apparatus as defined by claim 1 wherein the package base is a premolded-type package base.

3. The apparatus as defined by claim 1 wherein the lid has a top member and a downwardly extending member extending toward the package base, the downwardly extending member electrically contacting the given portion of the leadframe.

4. The apparatus as defined by claim 3 wherein the package base is substantially flat, the lid having an acoustic port, the package base, downwardly extending member and top member forming the chamber, the chamber opening to the acoustic port.

5. The apparatus as defined by claim 1 wherein the leadframe has the given portion and a different portion, the given portion being electrically isolated from the different portion enabling the two leadframe portions to have different potentials.

6. The apparatus as defined by claim 1 wherein the lid has substantially the same potential as the given portion of the leadframe.

7. The apparatus as defined by claim 1 wherein the lid has a conductive layer that electrically connects with the given portion of the leadframe.

8. The apparatus as defined by claim 1 wherein the package base includes a base portion and a wall extending toward the lid, the wall comprising a conductor that electrically connects the lid to the leadframe.

9. The apparatus as defined by claim 1 wherein the package base has a wall with a recess that exposes the given portion of the leadframe, the lid having a downwardly extending portion secured in registry with the recess to electrically contact the given portion of the leadframe.

10. The apparatus as defined by claim 1 wherein the microphone comprises a MEMS device.

11. A method of forming a transducer device, the method comprising:
providing a premolded type leadframe package base having a ground lead and a signal lead;
securing a MEMS microphone to the package base;
securing a lid to the package base to form an internal chamber containing the microphone; and
electrically connecting the lid to the ground lead to cause the lid and ground lead to have substantially the same potential.

12. The method as defined by claim 11 further comprising electrically connecting the MEMS microphone to the signal lead.

13. The method as defined by claim 11 wherein the lid has a top face and a wall extending generally downwardly from the top face, the wall having a conductive portion, the method further comprising:
electrically connecting the conductive portion of the wall to the ground lead.

14. The method as defined by claim 11 wherein securing the lid to the package base comprises applying a conductive adhesive between the lid and package base to provide an electrical path between the package base and the lid.

15. The method as defined by claim 11 wherein the MEMS microphone includes a die having a bottom surface, securing a MEMS microphone to the package base comprises securing the bottom face of the MEMS microphone to the ground lead.

16. An transducer comprising:
a MEMS microphone;
a premolded package base having a leadframe; and
a lid coupled with the package base, the lid and package base forming a chamber for containing the microphone; and
means for electrically connecting the lid with a given portion of the leadframe.

17. The transducer as defined by claim 16 wherein the electrically connecting means comprises a conductor on the lid coupled with the given portion of the leadframe.

18. The apparatus as defined by claim 16 wherein the lid has a top member and a downwardly extending member extending toward the package base, the downwardly extending member electrically contacting the given portion of the leadframe.

19. The apparatus as defined by claim 16 wherein the leadframe has the given portion and a different portion, the given portion being electrically isolated from the different portion.

20. The apparatus as defined by claim 16 wherein the package base includes a base portion and a wall extending toward the lid, the wall comprising a conductor, the electrically connecting means comprising the conductor.
